(19) United States
(12) Patent Application Publication
(10) Pub. No.: US 2008/0172463 A1
(43) Pub. Date: Jul. 17, 2008

(54) Method and System For Providing Group Chat Service

(75) Inventors: Pengcheng Qin, Shenzhen (CN); Youyao Lin, Shenzhen (CN); Zhibin Fan, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: TENCENT TECHNOLOGY (SHENZHEN) COMPANY LIMITED, Shenzhen, Guangdong (CN)

(21) Appl. No.: 11/912,496

(22) PCT Filed: Mar. 21, 2006
(86) PCT No.: PCT/CN2006/000450

§ 371 Date: Oct. 24, 2007

(30) Foreign Application Priority Data
Apr. 30, 2005 (CN) 200510070359.7

(51) Int. Cl. G06F 15/16

(52) U.S. Cl. 709/204

(57) ABSTRACT

A method for providing a group chat service includes: creating a chat group including a first member and one or more second members; establishing a P2P connection to each of the second members; receiving audio data uploaded from the second members through the P2P connections; mixing the audio data received and audio data of the first member to generate mixed audio data and transmitting the mixed audio data to the second members through the P2P connections by the first member; receiving by the second members the mixed audio data. The present invention also discloses a system for providing a group chat service. According to the present invention, text chat and audio chat are handled differently, thus the network bandwidth requirement and computer hardware requirement of group chat for forwarding the audio data are lowered, and the data volume transmitted by the network is reduced.

### FIELD OF THE INVENTION

The present invention relates to an instant messaging technology, and more particularly to a method and system for providing a group chat service in an instant messaging system.

### BACKGROUND OF THE INVENTION

Computer network communication, as an advanced communication method, is gradually changing people's life. Accordingly, instant messaging based on the computer network communication has been increasingly attracting people's attention and appreciation because of its characteristics such as convenience, rapidness and low cost. At present, there are two eye-catching trends in the instant messaging field. One is one-to-multiple or multiple-to-multiple communications derived from previous one-to-one communications, and the other is audio chat added to sole text chat. As a result, chat among more than two people by means of both text and audio, i.e. group chat which combines the two trends by including both the text chat and the audio chat, has become a hot issue during the development of the instant messaging technology. For example, companies or organizations can save time and space needed for meetings or daily communications by providing group chat for their members.

In the prior art, there are two common solutions for providing a group chat service. One adopts conventional Peer-to-Peer (P2P) technique, and the other adopts server forwarding process.

A method for providing group chat by adopting the P2P technique is described hereinafter. FIG. 1 is a schematic diagram showing a structure for providing group chat by adopting P2P technique. As shown in FIG. 1, it is supposed that four members A, B, C and D belong to a chat group, P2P connections are established between each two members of the four, i.e. between A and B, B and C, C and D, and D and A, respectively. When the user of member A speaks, it is necessary to transmit the content of the speech to members B, C and D one by one through the P2P connections, i.e. to communicate on three P2P connections.

Obviously, the limitation of the method above lies in that it is necessary to maintain the P2P connections between one member and the other members in the group since each of the users of the members acts as speaker and listener in turn during the group chat, and a failed P2P connection will affect the whole communication performances. In practical applications, along with increasing amount of members participated in the chat group, the number of P2P connections needed for group chat increases. In this way, some members with poor network circumstances may suffer from inadequate bandwidth, therefore the success rate for providing group chat is lowered.

A method for providing group chat by adopting server forwarding process is described hereinafter. FIG. 2 is a schematic diagram showing a structure for providing group chat by adopting server forwarding process. As shown in FIG. 2, it is still supposed that there are four members A, B, C and D in a chat group. Instead of connecting directly to one another, each of the four members connects to a central server which provides instant messaging service. When the user of member A speaks, the member A transmits the data and the group member list to the central server, and the server forwards the data to the members in the group member list, i.e. members B, C and D, and returns the forwarding result to the member A.

The advantage of the above method lies in that each member in the chat group consumes least resources and results in least cost because each member in the chat group only needs to keep one connection which leads to the central server, and does not have to maintain the connections with other members. However, the disadvantage of the method is also obvious for that the central server forwards not only text data but also audio data, which makes the central server loaded down. Moreover, the central server generally forwards audio data from a number of chat groups, thus the resources needed by the central server are greatly increased, which places high requirements for the hardware of the central server. Particularly, when the resource consumed by the central server reaches a certain threshold, the success rate for providing group chat will be lowered greatly.

### SUMMARY OF THE INVENTION

The main objective of the present invention is to provide a method and system for providing a group chat service, which will lower the network bandwidth requirement and computer hardware requirement of group chat.

The objective of the present invention is achieved with the following technical solution.

A method for providing a group chat service includes:

A. creating a chat group including a first member and one or more second members, wherein the first member establishes a P2P connection to each of the second members;

B. receiving audio data uploaded from the second members through the P2P connections, mixing the audio data received and audio data of the first member to generate mixed audio data, and transmitting, by the first member, the mixed audio data to the second members through the P2P connections; and

receiving, by the second members, the mixed audio data.

In the step a, the first member is an initiator of the chat group or a group member designated by the initiator of the chat group.

In the step a, designating a group member as the first member by the initiator, of the chat group further comprises:

transmitting, by the initiator of the chat group, a designation request containing a group member list to a group member, and designating the group member as the first member upon receiving a designation response from the group member;

wherein in the step A, establishing a P2P connection to each of the second members comprises:

establishing, by the first member, the P2P connections to the other members in the group member list.

In the step b, mixing the audio data received and audio data of the first member to generate mixed audio data comprises:

for each one of the second members in the chat group mixing, by the first member, the audio data of the first member and the audio data from all the other second members to generate the mixed audio data.

The step b further comprises, after generating the mixed audio data and before transmitting the mixed audio data, a step of: compressing and encoding, by the first member, the mixed audio data to generate compressed mixed audio data; and

the step b further comprises: decompressing, by the second members, the mixed audio data received; and playing, by the second members, the mixed audio data decompressed.

In the step b, transmitting the mixed audio data by the first member further comprises:

transmitting the generated mixed audio data by the first member to the second members in real time; or

transmitting the mixed audio data generated during a predefined time period by the first member to the second members.

The method further comprises, after the step a, a step of:

establishing a P2P connection by the first member to a user terminal which was not in the group and adding the user terminal as a group member.

The method further comprises, after the step a, a step of:

releasing, by the first member, the P2P connection to one of the second members and deleting the second member from the group.

The method further comprises, after the step a, a step of:

releasing, by one of the second members, the P2P connection to the first member and exiting the group.

After the step a, the method further comprises:

transmitting, by the initiator, the group member list to a central server providing the instant message service;

uploading, by a speaking member in the group, text data to the central server;

forwarding, by the central server, the text data uploaded by the speaking member to all the members in the group member list except the speaking member.

Another method for providing a group chat service comprises:

creating a chat group, wherein members of the chat group carry out group audio chat and group text chat;

wherein carrying out the group audio chat comprises: a, designating a group member as a first member and the other group members as second members, wherein the first member establishes a P2P connection to each of the second members; b, receiving the audio data uploaded by the second members through the P2P connections, mixing the audio data received and the audio data of the first member to generate mixed audio data, and transmitting, by the first member, the mixed audio data to the second members through the P2P connections; and receiving, by the second members, the mixed audio data;

wherein carrying out the group text chat comprises: transmitting, by an initiator of the chat group, a group member list to a central server providing an instant message service; uploading, by a member of the chat group, text data to the central server; and forwarding, by the central server, the text data uploaded by the member to all the other members in the group member list.

In the step a, designating a group member as the first member comprises: designating the initiator of the chat group or another group member as the first member by the initiator of the chat group.

In the step a, designating another group member as the first member by the initiator of the chat group further comprises: transmitting, by the initiator of the chat group, a designation request containing a group member list to a group member, and designating, by the initiator, the group member as the first member upon receiving a designation response from the group member;

wherein in the step a, establishing a P2P connections to each of the second members comprises:

establishing, by the first member, the P2P connections to other members in the group member list.

In the step a, mixing the audio data received and audio data of the first member to generate mixed audio data comprises:

for each one of the second members in the group, mixing, by the first member, the audio data of the first member and the audio data from all the other second member to generate the mixed audio data.

The step b further comprises, after receiving audio data and generating and before transmitting the mixed audio data to the second members, compressing and encoding, by the first member, the mixed audio data to generate compressed mixed audio data;

wherein the step b further comprises:

decompressing, by the second member, the received mixed audio data; and

playing, by the second member, the mixed audio data decompressed.

In the step b, generating and transmitting the mixed audio data to the second members comprises:

transmitting, by the first member, the mixed audio data generated to the second members in real time;

transmitting, by the first member, the mixed audio data generated during an interval to the second members.

The method further comprises, after the step a, a step of: establishing, by the first member, a P2P connection to a user terminal which was not in the group and adding the user terminal as a group member.

The method further comprises, after the step a, a step of: releasing the P2P connection to one of the second members by the first member and deleting the second member from the group.

The method further comprises, after the step a, a step of: releasing, by one of the second members, the P2P connection to the first member and exiting the group.

A system for providing a group chat service comprises a first member and one or more second members, wherein

the first member is connected to each of the second members through a P2P channel respectively, and is capable of receiving audio data uploaded by the second members, mixing the audio data received with the audio data of the first member to generate mixed audio data, and transmitting the mixed audio data to the second members.

The system further comprises a central server which is connected to the first and second members respectively, capable of receiving text data uploaded from a member among the first and second members, and forwarding the text data to the other members.

The first member is a computer terminal, and the second members are computer terminals, mobile phones or Personal Digital Assistants (PDAs).

Another system for providing a group chat service comprises a first member, one or more second members and a central server, wherein

the first member is connected to each of the second members through a P2P channel respectively, and is capable of receiving audio data uploaded by the second members, mixing the audio data received with the audio data of the first member to generate mixed audio data, and transmitting the mixed audio data to the second members;

the central server is connected to the first and second members respectively, and is capable of receiving text data uploaded by a member among the first and second members, and forwarding the text data to the other members.

It can be seen from the above technical solution that, according to the solution of the present invention, a member of the chat group acts as a host and the host establishes P2P connections to all the other members, mixes the audio data uploaded by the other members through the P2P connections with the audio data of the host to generate mixed audio data, and transmits the mixed audio data to the other members through the P2P connections. Compared with the prior art, the present invention has the following advantages. First, by only establishing the P2P connections between the host and each of the other members rather than establishing connections between each two members, the number of P2P connections is reduced and the network bandwidth requirement of group chat is lowered accordingly. Second, the host generates the mixed audio data from the received audio data and the audio data of the host and transmits the mixed audio data to the other members, the data quantity of the forwarded audio data is greatly reduced, and since the host only forwards the audio data in one group, the resource occupancy and consumption of the host is reduced and meanwhile the data traffics in the network is effectively lowered. Finally, by handling the text chat and the audio chat in different ways, a real-time and correct text chat can be ensured while the disadvantages of the conventional audio chat is overcome, and the resources are thus utilized more efficiently. It is seen from the above description that the present invention can lower the network bandwidth requirement and the resource consumption of group chat, thereby increasing the success rate of group chat.

### BRIEF DESCRIPTION OF THE DRAWINGS

FIG. 1 is the schematic of a structure for providing a group chat service by adopting P2P technique in prior art.

FIG. 2 is the schematic of a structure for providing a group chat service by adopting server forwarding process in prior art.

FIG. 3 is a schematic of an improved structure for providing a group chat service in accordance with an embodiment of the present invention.

FIG. 4 is a flowchart of providing a group chat service in the embodiment of the present invention.

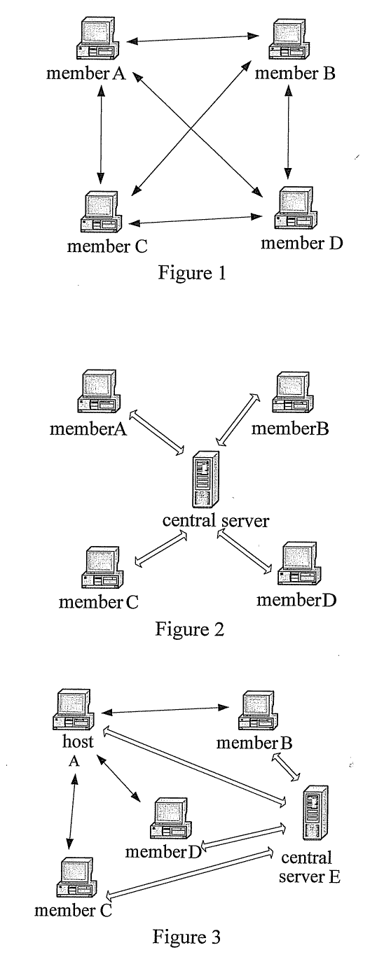

### DETAILED DESCRIPTION OF THE INVENTION

In order to make the object, solution and merits of the present invention clearer, a detailed description of the present invention is hereinafter given with reference to specific embodiments and the accompanying drawings.

FIG. 3 is a schematic of an improved structure for providing a group chat service in accordance with an embodiment of the present invention. As shown in FIG. 3, entities involved in group chat include a central server E, a host A and members B, C and D, wherein the host A and the members B, C and D are connected to the central server E respectively. The host A is connected to the members B, C and D directly through P2P channels respectively.

The feature of the present system is that the system handles text chat and audio chat in different ways. For text chat, a member uploads the text data to the central server when the user of the member is speaking, and the central server forwards the text data to the other members in the chat group respectively. For audio chat, the host A receives the audio data uploaded from the members B, C and D through the P2P channels in real-time, mixes the received audio data with audio data of host A to generate mixed audio data, and then transmits the mixed audio data to the members B, C and D through the P2P channels respectively.

Preferably, the host A is a computer terminal, and members B, C and D can be terminals such as computer terminals, mobile phones or Personal Digital Assistants (PDAs).

Based on the above structure, the embodiment of the present invention provides a method for providing group chat, wherein the text data and the audio data for the group chat are handled in different ways.

According to the embodiment of the present invention, the text data is processed by the central server adopting a server forwarding process as described in the background. Since the volume of the text data is relatively small and the group members transmit data packets to the central server only when the users of the members speak, and moreover, the central server has already had a perfect mechanism to process the text data, thereby the stability and the accuracy of receiving and transmitting the text data in the ongoing group chat are greatly secured.

According to the embodiment of the present invention, the audio data is processed in a way different from that in the prior art. The initiator of a chat group selects a group member as the host, and the host establishes P2P connections to all the other members respectively. Once the connections are established, the host receives audio data via the P2P connections from all the other members, mixes the audio data of the host with the audio data from the members, and then distributes the mixed audio data to the other members via the P2P connections.

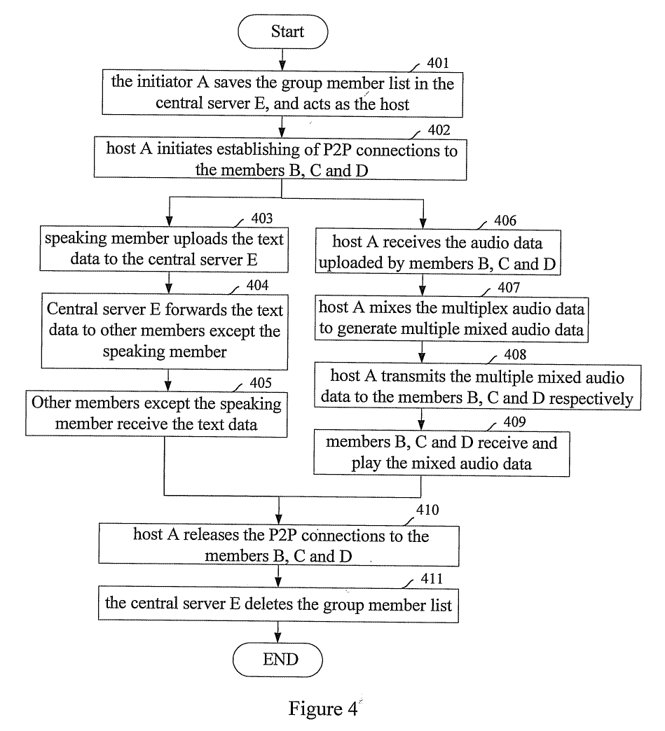

FIG. 4 is a flowchart for providing a group chat service in the embodiment of the present invention. In this embodiment, A is the initiator of the chat group, B, C and D are group members and E is the central server. All the group members have logged into the central server and remained online. As shown in FIG. 4, the flow of the embodiment mainly includes the following steps.

In step 401, the initiator A of the chat group generates a group member list and submits the list to the central server E. The list contains members A, B, C and D, and the initiator A designates itself as the host of the chat group.

In step 402, the host A initiates connection requests to establish P2P connections to the members B, C and D respectively, i.e. P2P connections between A and B, A and C, and A and D, and a group chat invitation is also included in each connection request.

In step 403, if a group member determines that the inputted data is text data, the group member is regarded as the speaking member and the speaking member uploads the text data to the central server E.

In step 404, the central server E receives the text data from the speaking member and forwards the text data to all the other members in the group member list except the speaking member.

In step 405, all the other members except the speaking member receive the text data of the speaking member.

In step 406, once the P2P connections are established, the host A receives the audio data uploaded through the P2P connections in real-time, i.e. receives the audio data from the members B, C and D respectively in real-time.

Audio chat is different from text chat in that the audio data are generated regardless of whether the users of the group members are speaking or not, and the audio data may be uploaded from group members except the host to the host. If the users of the members are not speaking, the uploaded audio data shall be silent audio frames, and the audio data generated by the host are also silent audio frames if the user of the host is not speaking.

In step 407, for everyone of the group members the host A generates and saves mixed audio data which are generated by mixing the audio data of all the other group members except the one group member. In this embodiment, the host A generates and saves three sets of mixed audio data. In detail, the host A generates and saves mixed audio data 1 for the member B by mixing the audio data uploaded from the members C and D and the audio data of the host A, generates and saves mixed audio data 2 for the member C by mixing the audio data uploaded from the members B and D and the audio data of the host A, and generates and saves mixed audio data 3 for the member D by mixing the audio data uploaded from the members B and C and the audio data of the host A.

The host A can save the mixed audio data in any accessible storage. Preferably, the host A saves the mixed audio data in a buffer of the host A.

In step 408, the host A transmits the generated mixed audio data to the group members through the P2P connections in real-time, and in this embodiment, the host A transmits mixed audio data 1, mixed audio data 2 and mixed audio data 3 to the members B, C and D respectively.

In step 409, the members B, C and D receive and play the mixed audio data from the host A through the P2P connections.

In step 410, when the group chat finishes, the host A releases the P2P connections to the members B, C and D respectively and at the same time transmits an end-of-chat message to the central server E.

In step 411, the central server E deletes the saved member list of the chat group.

Thus the group chat among the group members A, B, C and D is accomplished.

It should be noted that, the above steps 403 to 405 are the procedure of processing the text data in the group chat, the steps 406 to 409 are the procedure of processing the audio data in the group chat, and the two procedures may be performed in parallel.

In step 401, the initiator of the chat group acts as the host and initiates P2P connections to other group members. In other embodiments of the present invention, the initiator of the chat group may designate another group member as the host, because this embodiment places high requirements for computer hardware and network bandwidth of the host, and when the initiator can't satisfy the requirement, it is necessary to designate another group member as the host as long as the hardware and the network environment of the designated member meet the requirements so that the group chat can proceed successfully.

When the initiator designates another member as the host, the step 401 is divided into two sub-steps:

In step 4011, the initiator of the chat group generates a group member list and saves the list in the central server E, and at the same time the initiator of the chat group transmits a designation request containing the group member list to the designated member via the central server E;

In step 4012, if the designated member receiving the designation request accepts the designation of the initiator, the designated member returns a designation response to the initiator, and initiates P2P connections to the other group members according to the received group member list.

It can be seen in the steps 407 and 408 that the host in the embodiment generates and transmits the mixed audio data based on the following principles: the host mixes the audio data of all the other members except one member, and transmits the mixed audio data to the one member, i.e., the host generates and transmits the mixed audio data for each of the other group members. In this way, each group member can hear the audios of all the other group members. According to other embodiments of the present invention, in order to simplify the audio mixing process, the host can mix the audio of all the group members, generates a mixed audio data for all the other group members, and transmits this mixed audio data to all the other members respectively, in such a case the user of each member can hear his own voice and accordingly the audio communication performance of the group chat is poorer, but yet the implementation is simpler.

In step 407, the host generates and saves the mixed audio data after mixing multiple audio data. According to other embodiments of the present invention, after mixing the multiplex audio data, the host compresses and encodes the mixed audio data, and in step 408, the host transmits the compressed mixed audio data, then in step 409, the member that received the mixed audio data decompresses the compressed mixed audio data, therefore the volume of the audio data in the group chat can be effectively reduced.

In steps 407 and 408, the host transmits the generated mixed audio data to the other group members in real-time. According to other embodiments of the present invention, the host can transmit the mixed audio data at intervals, i.e. an interval is set in advance and the host transmits the mixed audio data generated during the interval to the other group members.

To transmit the mixed audio data at intervals, the host allocates in advance a storage space for every group members except the host, and saves the mixed audio data in the storage space allocated in advance while generating the mixed audio data. For example, if the interval is set to 5 seconds, the host saves the mixed audio data generated for each of the group members in the storage space pre-allocated to the members. And every 5 seconds the host obtains the mixed audio data generated in the 5-second interval from the corresponding storage space and transmits the mixed audio data to the other group members.

In the above embodiment, the initiator generates a group member list at the beginning of the group chat, and the group chat proceeds among the group members in the group member list. In other embodiments of the present invention, the host may add or delete members of the chat group during the group chat. The host establishes the P2P connection to the user to be added, and requests the central server to add the user into the group member list, therefore the user is added into the chat group. Similarly, the host releases the P2P connection to the member to be deleted, and requests the central server to delete this member from the chat group member list, therefore the member is deleted from the chat group. Moreover, if a group member other than the host exits the chat group voluntarily, the group member can release the P2P connection to the host, and the host will request the central server to delete the member from the group member list.

It can be seen from the above technical solutions, the method of the present invention improves the first and second methods in the prior art, which is explained as follows.

According to the first method in the prior art, the P2P connections are established between every two members of the chat group. Provided the number of the group members is N, the number of P2P connections which should be established is

$$\frac{N ( N - 1 )}{2} .$$

In this embodiment of the present invention, it is only necessary to establish the P2P connections between the host and all the other members, and when the number of the group members is N, the number of P2P connections which should be established is only (N−1). Compared with the first method in the prior art, the embodiment of the present invention only places higher requirements for computer hardware and network environment of the host without any other particular requirement for computer hardware and network environment of the other group members. It can be seen from the comparison that, as the number N increases, the number of needed P2P connections is greatly reduced in the embodiment of the present invention, and the advantage of the present invention becomes more obvious, and thus the present invention is particularly suitable for applications in which there are numerous members in the chat groups. Moreover, since the P2P connections are established between the host and each of the other group members, the host can add or delete group members conveniently, and other members can exit the chat group conveniently as well, which facilitates the control over the chat group members.

According to the second method in the prior art, the server takes charge of forwarding the audio data of all the members in the chat group, and when the number of chat groups whose audio data are forwarded by the server increases, the load of the server and the data traffic in the network will increase greatly. In the embodiment of the present invention, one member of the chat group acts as the host which mixes the received audio data of its own group members and transmits the mixed audio data to the other members. For example, the tape length used for recording a solo of 3 minutes is the same as that used for recording a chorus of 3 minutes, similarly, as the group members receive the mixed audio data, they will receive the same data quantity no matter how many users of the members are speaking in the chat group. Since the data quantity is under control, the impact to the audio quality caused by the network delay and congestion can be effectively mitigated. It can be seen from the above comparison that the embodiment of the present invention can reduce the load of the central server while greatly reducing the data traffic in the network.

Another outstanding advantage of the present invention is that the text data and the audio data of the group chat are processed differently, i.e., the text data is processed with the method in the prior art while the audio data is processed with the improved method in accordance with the present invention. Therefore, a real-time and accurate text chat can be ensured while the disadvantage of the conventional audio chat, i.e. high requirements for the network bandwidth and the computer hardware, is overcome, and at the same time the data traffic in the network are reduced so that the resource can be used more effectively.

The methods and systems of the present invention can be modified appropriately during specific implementation to meet the detailed requirements of specific cases. It is thereby understood that the specific embodiments according to the present invention are just demonstrative, and are not for use in limiting the protection scope of this invention.

1. A method for providing a group chat service, comprising:
creating a chat group including a first member and one or more second members, wherein the first member establishes a peer to peer, P2P, connection to each of the second members;
receiving audio data uploaded from the second members through the P2P connections, mixing the audio data received and audio data of the first member to generate mixed audio data, and transmitting, by the first member, the mixed audio data to the second members through the P2P connections; and
receiving, by the second members, the mixed audio data.

2. The method as claimed in claim 1, wherein the first member is an initiator of the chat group.

3. The method as claimed in claim 1, comprising:
transmitting, by an initiator of the chat group, a designation request containing a group member list to a group member;
designating, by the initiator, the group member as the first member upon receiving a designation response from the group member;
wherein establishing a P2P connection to each of the second members comprises:
establishing, by the first member, the P2P connections to the other members in the group member list.

4. The method as claimed in claim 1, wherein mixing the audio data received and audio data of the first member to generate mixed audio data comprises:
for each one of the second members in the chat group mixing, by the first member, the audio data of the first member and the audio data from all the other second members to generate the mixed audio data.

5. The method as claimed in claim 4, further comprising:
before transmitting the mixed audio data to the second members, compressing and encoding, by the first member, the mixed audio data to generate compressed mixed audio data;
wherein receiving the mixed audio data comprises:
decompressing, by the second members, the mixed audio data received; and
playing, by the second members, the mixed audio data decompressed.

6. The method as claimed in claim 1, wherein transmitting the mixed audio data to the second members comprises:
transmitting, by the first member, the mixed audio data generated to the second members in real time.

7. The method as claimed in claim 1, further comprising:
establishing, by the first member, a P2P connection to a user terminal which was not in the group and adding the user terminal as a group member.

8. The method as claimed in claim 1, further comprising:
releasing, by the first member, the P2P connection to one of the second members and deleting the second member from the group.

9. The method as claimed in claim 1, further comprising:
releasing, by one of the second members, the P2P connection to the first member and exiting the group.

10. The method as claimed in claim 1, further comprising:
transmitting, by the initiator, the group member list to a central server providing the instant message service;
uploading, by a speaking member in the group, text data to the central server;
forwarding, by the central server, the text data uploaded by the speaking member to all the members in the group member list except the speaking member.

11. A method for providing a group chat service, comprising:
creating a chat group, wherein members of the chat group carry out group audio chat and group text chat;
wherein carrying out the group audio chat comprises: designating a group member as a first member and the other group members as second members, wherein the first member establishes a peer to peer, P2P, connection to each of the second members; receiving the audio data uploaded by the second members through the P2P connections, mixing the audio data received and the audio data of the first member to generate mixed audio data, and transmitting, by the first member, the mixed audio data to the second members through the P2P connections; and receiving, by the second members, the mixed audio data;
wherein carrying out the group text chat comprises: transmitting, by an initiator of the chat group, a group member list to a central server providing an instant message service; uploading, by a member of the chat group, text data to the central server; and forwarding, by the central server, the text data uploaded by the member to all the other members in the group member list.

12. (canceled)

13. The method as claimed in claim 11, further comprising:
transmitting, by an initiator of the chat group, a designation request containing a group member list to a group member, and designating, by the initiator, the group member as the first member upon receiving a designation response from the group member;
wherein establishing P2P connections to each of the second members comprises:
establishing, by the first member, the P2P connections to other members in the group member list.

14. The method as claimed in claim 11, wherein mixing the audio data received and audio data of the first member to generate mixed audio data comprises:
for each one of the second members in the group, mixing, by the first member, the audio data of the first member and the audio data from all the other second member to generate the mixed audio data.

15. The method as claimed in claim 14, further comprising:
after receiving audio data and generating and before transmitting the mixed audio data to the second members, compressing and encoding, by the first member, the mixed audio data to generate compressed mixed audio data;
wherein receiving the mixed audio data comprises:
decompressing, by the second member, the received mixed audio data; and
playing, by the second member, the mixed audio data decompressed.

16. The method as claimed in claim 11, wherein transmitting the mixed audio data to the second members comprises:
transmitting, by the first member, the mixed audio data generated to the second members in real time.

17. The method as claimed in claim 11, further comprising: establishing, by the first member, a P2P connection to a user terminal which was not in the group and adding the user terminal as a group member.

18. The method as claimed in claim 11, further comprising:
releasing, by the first member, the P2P connection to one of the second members and deleting the second member from the group.

19. The method as claimed in claim 11, further comprising:
releasing, by one of the second members, the P2P connection to the first member and exiting the group.

20. A system for providing a group chat service, comprising a first member and one or more second members, wherein
the first member is connected to each of the second members through a peer-to-peer, P2P, channel respectively, and is capable of receiving audio data uploaded by the second members, mixing the audio data received with the audio data of the first member to generate mixed audio data, and transmitting the mixed audio data to the second members.

21. The system as claimed in claim 20, further comprising a central server, which is connected to the first and second members respectively, capable of receiving text data uploaded from a member among the first and second members, and forwarding the text data to the other members.

22. The system as claimed in claim 20, wherein the first member is a computer terminal; the second members are one of computer terminals, mobile phones and Personal Digital Assistants, PDAs.

23. A system for providing a group chat service, comprising a first member, one or more second members and a central server, wherein
the first member is connected to each of the second members through a peer-to-peer, P2P, channel respectively, and is capable of receiving audio data uploaded by the second members, mixing the audio data received with the audio data of the first member to generate mixed audio data, and transmitting the mixed audio data to the second members;
the central server is connected to the first and second members respectively, and is capable of receiving text data uploaded from a member among the first and second members, and forwarding the text data to the other members.

24. The method as claimed in claim 1, wherein transmitting the mixed audio data to the second members comprises:
transmitting, by the first member, the mixed audio data generated during an interval to the second members.

25. The method as claimed in claim 11, wherein the first member is an initiator of the chat group.

26. The method as claimed in claim 11, wherein transmitting the mixed audio data to the second members comprises:
transmitting, by the first member, the mixed audio data generated during an interval to the second members.
